(19) United States
(12) Patent Application Publication
(10) Pub. No.: US 2018/0037200 A1
(43) Pub. Date: Feb. 8, 2018

(54) VEHICLE TRAVELING CONTROL APPARATUS

(71) Applicant: Toyota Jidosha Kabushiki Kaisha, Toyota-shi Aichi-ken (JP)

(72) Inventors: Hirotada Otake, Susono-shi Shizuoka-ken (JP); Masaki Takano, Susono-shi Shizuoka (JP)

(21) Appl. No.: 15/490,083

(22) Filed: Apr. 18, 2017

(30) Foreign Application Priority Data
Aug. 8, 2016 (JP) 2016-155798

(51) Int. Cl. B60T 7/14; B60T 13/12; B60T 8/58; B60T 1/00; B60T 8/172

(52) U.S. Cl. CPC B60T 7/14; B60T 1/005; B60T 8/172; B60T 8/58; B60T 13/12; B60T 2201/02

(57) ABSTRACT

A vehicle traveling control apparatus of the disclosure stops a friction force application and maintains a vehicle at a stopped state by an engagement lock when a first time elapses from a stop of the vehicle by a particular control. The apparatus stops the friction force application and maintains the vehicle at the stopped state by the engagement lock when a second time shorter than the first time elapses from the stop of the vehicle by a forced stop control which is executed when a driver is under an abnormal state.

### CROSS-REFERENCE TO RELATED APPLICATIONS

This application claims priority to Japanese Patent Application No. 2016-155798 filed on Aug. 8, 2016, the entire contents of which are hereby incorporated by reference.

### BACKGROUND

### Field

The disclosure relates to a vehicle traveling control apparatus for braking a vehicle to stop the vehicle when a driver of the vehicle is under an abnormal state that the driver loses an ability of driving the vehicle.

### Description of the Related Art

There is proposed an apparatus which determines whether or not a driver of a vehicle is under an abnormal state that the driver loses an ability of driving the vehicle, for example, a state that the driver sleeps and a state that a mind and body function of the driver stops and which execute a forced stop control for forcibly stopping the vehicle by applying a friction force to the vehicle to brake the vehicle when determining that the driver is under the abnormal state (refer to WO 2012/105030). Hereinafter, this apparatus will be referred to as “the conventional apparatus”.

The conventional apparatus includes a stop request button which is operated for requesting the stop of the forced stop control.

When a stop of the forced stop control is requested, the conventional apparatus stops a friction force application for applying the friction force to brake the vehicle or maintain the vehicle at a stopped state.

After the vehicle is stopped deriving from the determination that the driver is under the abnormal state, a rescuer and the like for rescuing the driver may mistakenly operate the stop request button. In this case, if the vehicle is maintained at the stopped state by the friction force application, the friction force application is mistakenly stopped. At this time, if the driver operates an acceleration pedal, the vehicle may be suddenly accelerated during a rescuing of the driver.

### SUMMARY

The disclosure has been made for solving the aforementioned problem.

An object of the disclosure is to provide a vehicle traveling control apparatus which can prevent the vehicle from being suddenly accelerated when the stop of the forced stop control is requested while the vehicle is maintained at the stopped state.

A vehicle traveling control apparatus according to the disclosure (hereinafter, will be referred to as “the present apparatus”) is applied to a vehicle. The vehicle comprises a friction braking device (41, 42, 51) and a lock device (23, 24). The friction braking device (41, 42) performs a friction force application for applying a friction force to the vehicle to brake the vehicle. The lock device (23, 24) performs an engagement lock for locking at least one wheel of the vehicle by engaging a lock member (25) with a rotation member (27) which rotates together with the at least one wheel.

The present apparatus comprises an electric control unit (10, 30, 40, 50). The electric control unit is configured to continuously determine whether or not a driver of the vehicle is under an abnormal state that the driver loses an ability of driving the vehicle (refer to processes of a step 515 in FIG. 5, a step 610 in FIG. 6 and a step 715 in FIG. 7). The electric control unit is further configured to execute a forced stop control for stopping the vehicle by braking the vehicle by the friction force application (refer to a process of a step 725 in FIG. 7) in response to the electric control unit determining that the driver is under the abnormal state (refer to a determination “Yes” at the step 715 in FIG. 7).

The electric control unit is further configured to execute a particular control for stopping the vehicle by braking the vehicle by the friction force application when a predetermined vehicle stop condition is satisfied while the electric control unit determines that the driver is not under the abnormal state. The electric control unit is further configured to perform one of a stop of the friction force application and a permission of a stop of the friction force application when a stop of the forced stop control is requested while the vehicle is maintained at a stopped state by the friction force application.

In the present apparatus, a time predicted to be taken until a start of a traveling of the vehicle is requested when the vehicle stopped by the particular control, is shorter than a time predicted to be taken until the start of the traveling of the vehicle is requested when the vehicle stopped by the forced stop control.

The electric control unit is configured to stop the friction force application and maintain the vehicle at the stopped state by the engagement lock (refer to a process of a step 425 in FIG. 4) when the vehicle is maintained at the stopped state by the friction force application at a time of an elapse of a first time (Taccth) from a time of a stop of the vehicle (refer to a determination “Yes” at a step 420 in FIG. 4) by the friction force application in the particular control (refer to determinations “Yes” at steps 405, 410 and 415 in FIG. 4).

The electric control unit is configured to stop the friction force application and maintain the vehicle at the stopped state (refer to a process of a step 740 in FIG. 7) by the engagement lock when the vehicle is maintained at the stopped state by the friction force application at a time of an elapse of a second time shorter than the first time (Taccth) from the time of the stop of the vehicle by the friction force application in the forced stop control (refer to a determination “Yes” at a step 705 in FIG. 7 and a determination “No” at a step 710 in FIG. 7).

In the present apparatus, the particular control may be a following-travel inter-vehicle-distance control for controlling an acceleration and a deceleration of an own vehicle which is the vehicle such that a distance between the own vehicle and a preceding vehicle traveling in front of the own vehicle is maintained at a set distance (Dtgt).

In the present apparatus, the friction braking device may be a hydraulic braking device (41, 42) for generating the friction force by hydraulic pressure. Further, in the present apparatus, the second time may be set to zero.

When the vehicle is maintained at the stopped state by the engagement lock, it is necessary to release the engagement lock in order to start the traveling of the vehicle. Thus, when the vehicle is maintained at the stopped state by the engagement lock, the traveling of the vehicle cannot be quickly started, compared with a case that the vehicle is maintained at the stopped state by the friction force application.

The time predicted to be taken until the start of the traveling of the vehicle is requested when the vehicle is stopped by the particular control is shorter than the time predicted to be taken until the start of the traveling of the vehicle is requested when the vehicle is stopped by the forced stop control.

Therefore, when the vehicle is stopped by the particular control, a possibility that a quick start of the traveling of the vehicle is requested after the vehicle is stopped, is large.

Therefore, when the vehicle is stopped by the particular control, the vehicle may be maintained at the stopped state by the friction force application in order to quickly start the traveling of the vehicle. In particular, when the particular control is the following-travel inter-vehicle-distance control and the vehicle is stopped by the following-travel inter-vehicle-distance control, the possibility that the quick start of the traveling of the vehicle is requested after the vehicle is stopped, is large.

With the present apparatus, when the vehicle is stopped by the particular control, the friction force application is stopped and the vehicle is maintained at the stopped state by the engagement lock at the time of the elapse of the first time after the vehicle is stopped. In this regard, the first time is longer than the second time, for which the friction force application continues after the vehicle is stopped by the forced stop control. Thus, a possibility that the traveling of the vehicle can be quickly started, is large.

On the other hand, the time predicted to be taken until the start of the traveling of the vehicle is requested when the vehicle is stopped by the forced stop control, is longer than the time predicted to be taken until the start of the traveling of the vehicle is requested when the vehicle is stopped by the particular control. Thus, when the vehicle is stopped by the forced stop control, the possibility that the quick start of the traveling of the vehicle is requested, is large.

Therefore, if the friction force application is stopped and the vehicle is maintained at the stopped state by the engagement lock soon after the vehicle is stopped, a possibility that a problem regarding the start of the traveling of the vehicle arises, is small. Further, when a rescuer for rescuing the driver under the abnormal state mistakenly requests a stop of the forced stop control while the vehicle is maintained at the stopped state by the friction force application, the friction force application is stopped or the stop of the friction force application is permitted. In this case, when the driver operates an acceleration pedal, the vehicle may be suddenly accelerated while the rescuer rescues the driver. Therefore, the vehicle may be maintained at the stopped state by the engagement lock which is not stopped when the stop of the forced stop control is requested.

Further, when the vehicle is maintained at the stopped state by the friction force application for a long time, a temperature of the friction braking device may increase excessively. A time taken until the start of the traveling of the vehicle is requested after the vehicle is stopped by the forced stop control, may be longer than a time taken until the start of the traveling of the vehicle is requested after the vehicle is stopped by the particular control. Therefore, when the vehicle is stopped by the forced stop control, the friction force application may be stopped and the vehicle may be maintained at the stopped state by the engagement lock soon after the vehicle is stopped in order to prevent the temperature of the friction braking device from increasing excessively.

With the present apparatus, when the vehicle is stopped by the forced stop control, the friction force application is stopped and the vehicle is maintained at the stopped state by the engagement lock at the time of the elapse of the second time after the vehicle is stopped. In this regard, the second time is shorter than the first time, for which the friction force application continues after the vehicle is stopped by the particular control. Thus, the possibility of preventing the vehicle from being suddenly accelerated is large and the temperature of the friction braking apparatus can be prevented from excessively increasing.

In the above description, for facilitating understanding of the present disclosure, elements of the present disclosure corresponding to elements of an embodiment described later are denoted by reference symbols used in the description of the embodiment accompanied with parentheses. However, the elements of the present disclosure are not limited to the elements of the embodiment defined by the reference symbols. The other objects, features and accompanied advantages of the present disclosure can be easily understood from the description of the embodiment of the present disclosure along with the drawings.

### BRIEF DESCRIPTION OF THE DRAWINGS

FIG. 1 is a view for showing a general configuration of a vehicle traveling control apparatus according to an embodiment of the disclosure.

FIG. 2 is a view for showing a parking lock mechanism shown in FIG. 1.

FIG. 3 is a view used for describing an operation of the vehicle traveling control apparatus shown in FIG. 1.

FIG. 4 is a flowchart for showing a braking switching routine executed by a CPU of a driving assist ECU shown in FIG. 1.

FIG. 5 is a flowchart for showing a normal state routine executed by the CPU.

FIG. 6 is a flowchart for showing a provisional abnormal state routine executed by the CPU.

FIG. 7 is a flowchart for showing a conclusive abnormal state routine executed by the CPU.

FIG. 8 is a flowchart for showing a stop permission routine executed by the CPU.

### DETAILED DESCRIPTION

Below, with reference to the drawings, a vehicle traveling control apparatus (or a vehicle driving assist apparatus) according to an embodiment of the disclosure will be described.

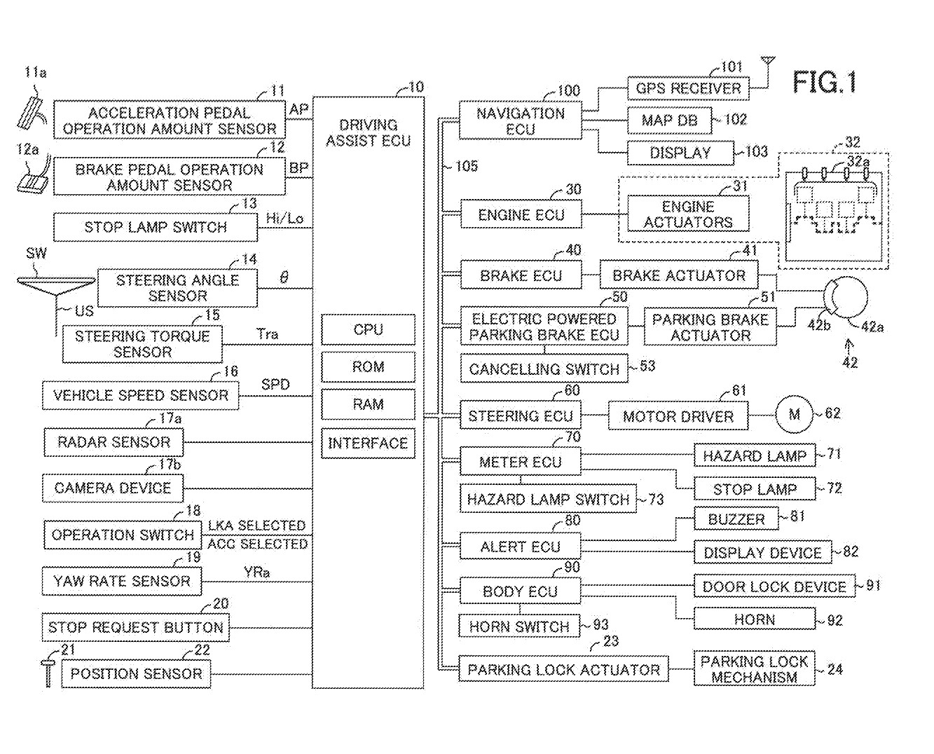

The vehicle traveling control apparatus according to the embodiment of the disclosure (hereinafter, will be referred to as “the embodiment apparatus”) is applied to a vehicle. Hereinafter, the vehicle will be referred to as “the own vehicle” in order to distinguish the vehicle, to which the embodiment apparatus is applied, from the other vehicles. As shown in FIG. 1, the embodiment apparatus includes a driving assist ECU 10, an engine ECU 30, a brake ECU 40, an electric powered parking brake ECU 50, a steering ECU 60, a meter ECU 70, an alert ECU 80, a body ECU 90 and a navigation ECU 100.

Each of the ECUs is an electric control unit including a microcomputer as a main part and the ECUs are connected to each other via a CAN (Controller Area Network) 105 such that the ECUs send and receive data to and from each other. In this description, the microcomputer includes a CPU, a ROM (a non-volatile memory), a RAM, an interface and the like. The CPU realizes various functions by executing instructions or programs or routines stored in the ROM. Some of the ECUs or all of the ECUs may be integrated to a single ECU.

The driving assist ECU 10 is electrically connected to sensors including switches described later and receives detection signals or output signals of the sensors, respectively. The sensors may be electrically connected to any of the ECUs other than the driving assist ECU 10. In this case, the driving assist ECU 10 receives the detection signals or the output signals of the sensors from the ECUs electrically connected to the sensors via the CAN 105.

An acceleration pedal operation amount sensor 11 detects an operation amount AP of an acceleration pedal 11a of the own vehicle and outputs a detection signal or an output signal representing the operation amount AP to the driving assist ECU 10. Hereinafter, the operation amount AP will be referred to as “the acceleration pedal operation amount AP”. A brake pedal operation amount sensor 12 detects an operation amount BP of a brake pedal 12a of the own vehicle and outputs a detection signal or an output signal representing the operation amount BP to the driving assist ECU 10. Hereinafter, the operation amount BP will be referred to as “the brake pedal operation amount BP”.

A stop lamp switch 13 outputs a low-level output signal to the driving assist ECU 10 when the brake pedal 12a is not depressed, that is, when the brake pedal 12a is not operated. On the other hand, the stop lamp switch 13 outputs a high-level output signal to the driving assist ECU 10 when the brake pedal 12a is depressed, that is, when the brake pedal 12a is operated.

A steering angle sensor 14 detects a steering angle θ of the own vehicle and outputs a detection signal or an output signal representing the steering angle θ to the driving assist ECU 10. A steering torque sensor 15 detects a steering torque Tra applied to a steering shaft US of the own vehicle by an operation of a steering wheel SW and outputs a detection signal or an output signal representing the steering torque Tra to the driving assist ECU 10. A vehicle speed sensor 16 detects a traveling speed SPD of the own vehicle and outputs a detection signal or an output signal representing the traveling speed SPD to the driving assist ECU 10. Hereinafter, the traveling speed SPD will be described as to “the vehicle speed SPD”.

A radar sensor 17a acquires information on a road in front of the own vehicle and three dimensional objects on the road. The three-dimensional objects include, for example, moving objects such as pedestrians, bicycles, vehicles and the like and motionless objects such as power poles, trees, guardrails and the like. Hereinafter, these three-dimensional objects will be referred to as “the target object”.

The radar sensor 17a includes a radar transmitting/receiving part (not shown) and a signal processing part (not shown). The radar transmitting/receiving part transmits radio waves each having a millimeter wave band to an area surrounding the own vehicle including an area in front of the own vehicle and receives the radio waves reflected by the target objects existing within a radiation range. Hereinafter, the radio wave having the millimeter wave band will be referred to as “the millimeter wave” and the radio wave reflected by the target object will be referred to as “the reflected wave”. The signal processing part acquires an inter-vehicle distance (i.e. a longitudinal distance), a relative vehicle speed, a lateral distance, a relative lateral vehicle speed and the like each time a predetermined time elapses on the basis of a phase difference between the transmitted millimeter wave and the received reflected wave, a damping level of the received reflected wave with respect to the transmitted millimeter wave, a time from a transmission of the millimeter wave to a reception of the reflected wave and the like.

A camera device 17b includes a stereo camera (now shown) and an image processing part (not shown). The stereo camera takes a pair of right and left images of landscapes at a right side of the own vehicle in front of the own vehicle and at a left side of the own vehicle in front of the own vehicle. The stereo camera acquires image data from the images of the landscapes at the right and left sides of the own vehicle. The image processing part determines whether or not the target object exists and calculates a relationship between the target object and the own vehicle and the like to output them on the basis of the image data of the images of the landscapes at the right and left sides of the own vehicle taken by the stereo camera.

The driving assist ECU 10 determines the relationship between the own vehicle and the target object, that is, determines target object information on the target object by combining the relationship between the own vehicle and the target object acquired by the radar sensor 17a and the relationship between the own vehicle and the target object acquired by the camera device 17b. Further, the driving assist ECU 10 realizes lane markers such as right and left lane lines provided on the road on the basis of the image data of the images of the landscapes at the right and left sides of the own vehicle taken by the camera device 17b and acquires a shape of the road such as a curvature radius of the road representing a degree of a curvature of the road, a positional relationship between the road and the own vehicle and the like. In addition, the driving assist ECU 10 acquires information on whether or not a road side wall exists on the basis of the image data acquired by the camera device 17b.

An operation switch 18 is operated by a driver of the own vehicle. The driver can control an execution of a lane keeping assist control (LKA) described later by operating the operation switch 18. Further, the driver can control an execution of a following-travel inter-vehicle-distance control such as an adaptive cruise control (ACC) described later by operating the operation switch 18.

A yaw rate sensor 19 detects a yaw rate YRa of the own vehicle and outputs a detection signal or an output signal representing the yaw rate YRa to the driving assist ECU 10.

A stop request button 20 is provided at a position which the driver can operates. When the stop request button 20 is not operated, the stop request button 20 outputs a low-level output signal to the driving assist ECU 10. On the other hand, when the stop request button 20 is operated, the stop request button 20 outputs a high-level output signal to the driving assist ECU 10.

A shift lever 21 can be set at any of a forward traveling range, a rearward traveling range, a neutral range and a parking range. Hereinafter, the forward traveling range will be referred to as “the D range”, the rearward traveling range will be referred to as “the R range”, the neutral range will be referred to as “the N range” and the parking range will be referred to as “the P range”.

A position sensor 22 is electrically connected to the shift lever 21. The position sensor 22 detects a range, at which the shift lever 21 is set, i.e., a set position of the shift lever 21 and outputs a detection signal or an output signal representing the set position of the shift lever 21 to the driving assist ECU 10. The driving assist ECU 10 acquires the set position of the shift lever 21 on the basis of the detection signal output from the position sensor 22.

When the shift lever 21 is set at the D range, the driving assist ECU 10 controls a transmission (not shown) of the own vehicle such that a torque output from an internal combustion engine 32 is supplied to drive wheels (not shown) of the own vehicle as a driving force for traveling the own vehicle forward. In this case, when the acceleration pedal 11a is operated, the torque is supplied from the engine 32 to the drive wheels and as a result, the own vehicle travels forward. Hereinafter, the torque output from the engine 32 will be referred to as “the engine torque”.

When the shift lever 21 is set at the R range, the driving assist ECU 10 controls the transmission such that the engine torque is supplied to the drive wheels as the driving force for traveling the own vehicle rearward. In this case, when the acceleration pedal 11a is operated, the engine torque is supplied to the drive wheel and as a result, the vehicle travels rearward.

When the shift lever 21 is set at the N range, the driving assist ECU 10 controls the transmission such that the engine torque is not supplied to the drive wheels. In this case, even when the acceleration pedal 11a is operated, the engine torque is not supplied to the drive wheels and as a result, the own vehicle does not travel.

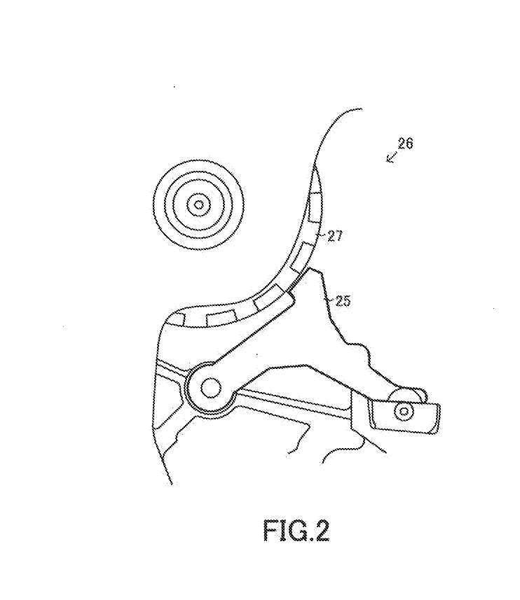

The driving assist ECU 10 is electrically connected to a parking lock actuator 23. The parking lock actuator 23 is connected to a parking lock mechanism 24. As shown in FIG. 2, the parking lock mechanism 24 includes a parking lock pawl 25 (i.e., an engagement member). The parking lock pawl 25 is provided to mechanically engage a parking gear 27 (i.e., a rotation member which rotates together with the drive wheels). The parking gear 27 is provided coaxially with an output shaft (not shown) of a transaxle 26. The parking lock pawl 25 engages mechanically with the parking gear 27 by an activation of the parking lock actuator 23.

When the shift lever 21 is set at the P range, the driving assist ECU 10 controls the transmission such that the engine torque is not supplied to the drive wheels and engages the parking lock pawl 25 with the parking gear 27 by controlling the activation of the parking lock actuator 23. In this case, even when the acceleration pedal 11a is operated, the engine torque is not supplied to the driver wheels. In addition, the parking gear 27 is locked by the parking lock pawl 25 such that the parking gear 27 is not rotated. As a result, the drive wheels of the own vehicle are locked. Thus, the own vehicle is maintained at a stopped state.

Hereinafter, a lock of the drive wheels by controlling an activation of the parking lock mechanism 24 will be referred to as “the engagement lock by the parking lock mechanism 24” or simply “the engagement lock”.

The engine ECU 30 is electrically connected to engine actuators 31 of the engine 32. The engine actuators 31 change operation states of a body 32a of the engine 32, respectively. In this embodiment, the engine 32 is a gasoline-fuel-injection spark-ignition type multi-cylinder internal combustion engine and includes a throttle valve (not shown) for adjusting an amount of air flowing into combustion chambers (not shown) of the engine 32. The engine actuators 31 include at least a throttle valve actuator (not shown) for changing an opening degree of the throttle valve.

The engine ECU 30 can change the engine torque generated by the engine 32 by controlling activations of the engine actuators 31. The engine torque generated by the engine 32 is transmitted to the drive wheels through the transmission. Therefore, the engine ECU 30 can change an acceleration or an acceleration state by controlling the driving force supplied to the own vehicle, in particular, to the drive wheels by controlling the activations of the engine actuators 31.

The brake ECU 40 is electrically connected to a brake actuator 41. The brake actuator 41 is provided in a hydraulic circuit provided between a master cylinder (not shown) for pressurizing hydraulic oil by a depression force of the brake pedal 12a and a friction brake mechanism provided in right and left front and rear wheels of the own vehicle. The friction brake mechanism 42 includes brake discs 42a each secured to the corresponding wheel of the own vehicle and brake calipers 42b secured to the body of the own vehicle at the corresponding wheel.

The brake actuator 41 adjusts a hydraulic pressure supplied to a wheel cylinder (not shown) in each of the brake caliper 42b, depending on a command sent from the brake ECU 40 to activate the wheel cylinder by the hydraulic pressure to press a brake pad (not shown) on the brake disc 42a, thereby to generate a friction braking force on the brake disc 42a. Therefore, the brake ECU 40 can control an activation of the brake actuator 41 to control a braking force applied to the own vehicle, in particular, to the wheels.

Hereinafter, an application of the friction force to the own vehicle by controlling an activation of the brake actuator 41 to brake the own vehicle or maintain the own vehicle at the stopped state will be referred to as “the friction force application by the friction brake mechanism 42” or simply “the friction force application”.

The electric powered parking brake ECU 50 is electrically connected to a parking brake actuator 51. The parking brake actuator 51 generates the friction braking force by pressing the brake pad on the brake disc 42a. Alternatively, when the own vehicle includes drum brakes in the wheels of the own vehicle, respectively, the parking brake actuator 51 generates the friction braking force by pressing a shoe on a drum which rotates together with the corresponding wheel. Therefore, the electric powered parking brake ECU 50 can apply the friction braking force to the wheels by activating the parking brake actuator 51.

A canceling switch 53 is electrically connected to the electric powered parking brake ECU 50. When the cancelling switch 53 is operated, a stop of the application of the friction force to the wheels of the own vehicle is requested to the electric powered parking brake ECU 50.

The steering ECU 60 is a control device of a known electric powered steering system and is electrically connected to a motor driver 61. The motor driver 61 is electrically connected to a steering motor 62. The steering motor 62 is assembled in a steering mechanism (not shown) of the own vehicle including the steering wheel SW, the steering shaft US connected to the steering wheel SW, a steering gear mechanism (not shown) and the like. The steering motor 62 generates a torque by an electric power supplied from the motor driver 61 and uses the torque to apply a steering assist torque to the steering shaft US to steer the right and left steered wheels.

The meter ECU 70 is electrically connected to a digital display meter (not shown), a hazard lamp 71 and a stop lamp 72. The meter ECU 70 blinks the hazard lamp 71 and lights the stop lamp 72, depending on a command sent from the driving assist ECU 10.

The meter ECU 70 is electrically connected to a hazard lamp switch 73. When the hazard lamp switch 73 is operated while the hazard lamp 71 does not blink, the driving assist ECU 10 requests the meter ECU 70 to blink the hazard lamp 71. On the other hand, when the hazard lamp switch 73 is operated while the hazard lamp 71 blinks, the driving assist ECU 10 requests the meter ECU 70 to stop a blinking of the hazard lamp 71.

The alert ECU 80 is electrically connected to a buzzer 81 and a display device 82. The alert ECU 80 can perform an attention to the driver by causing the buzzer 81 to generate sounds, depending on a command sent from the driving assist ECU 10. In addition, the alert ECU 80 can cause the display device 82 to light an attention mark such as a warning lamp and/or display an attention message and an operation state of a driving assist control. Hereinafter, a generation of the sounds performed by the buzzer 81, a lighting of the attention mark performed by the display device 82 and the like will be referred to as “the non-driving-operation alert”.

The body ECU 90 is electrically connected to a door lock device 91 and a horn 92. The body ECU 90 causes the door lock device 91 to release a lock of doors (not shown) of the own vehicle, depending on a command sent from the driving assist ECU 10. Further, the body ECU 90 causes the horn 92 to generate sounds, depending on a command sent from the driving assist ECU 10.

The body ECU 90 is electrically connected to a horn switch 93. When the horn switch 93 is operated while the horn 92 generates the sounds, a stop of a sound generation performed by the horn 92 is requested to the body ECU 90.

The navigation ECU 100 is electrically connected to a GPS receiver 101 which receives a GPS detection signal for detecting a present position of the own vehicle, a map database 102 which stores a map information and the like, a touch-screen type display 103 which is a human-machine interface and the like. The navigation ECU 100 identifies the present position of the own vehicle on the basis of the GPS detection signal, performs various calculations on the basis of the present position of the own vehicle and the map information and the like stored in the map database 102 and performs a route guidance using the display 103.

The map information stored in the map database 102 includes road information. The road information includes parameters which show a road shape of each of segments of the road such as a road curvature radius or a road curvature which shows a degree of a curve of the road. The curvature corresponds to an inverse number of the curvature radius.

### Summary of Operation of Embodiment Apparatus

Next, a summary of an operation of the embodiment apparatus will be described. The driving assist ECU 10 of the embodiment apparatus is configured or programmed to execute the lane keeping control (LKA) and the following-travel inter-vehicle-distance control (ACC). Further, the driving assist ECU 10 determines whether or not the driver is under an abnormal state which the driver loses his/her ability of driving the own vehicle repeatedly when the lane keeping control and the following-travel inter-vehicle-distance control are executed. Hereinafter, the abnormal state which the driver loses his/her ability of driving the own vehicle will be simply referred to as “the abnormal state”. When the driver continues to be under the abnormal state at an elapse of a predetermined time from a time of first determining that the driver is under the abnormal state, the driving assist ECU 10 decelerates the own vehicle to stop the own vehicle.

Next, a summary of a process for stopping the own vehicle when the driver continues to be under the abnormal state will be described. In this regard, a determination of whether or not the driver is under the abnormal state is performed when a condition that the lane keeping control and the following-travel inter-vehicle-distance control are executed, is satisfied. Accordingly, the lane keeping control and the following-travel inter-vehicle-distance control will be described first.

<Lane Keeping Assist Control (LKA)>

The lane keeping control is a control for assisting a steering operation of the driver by applying the steering torque to the steering mechanism to keep the position of the own vehicle along a target traveling line within a lane, in which the own vehicle travels. Hereinafter, the lane, in which the own vehicle travels, will be referred to as “the traveling lane”. The lane keeping control is known (for example, refer to JP 2008-195402 A, JP 2009-190464 A, JP 2010-6279 A and JP 4349210 B). Therefore, below, the lane keeping control will be briefly described.

The driving assist ECU 10 identifies or acquire the right and left lane lines LR and LL of the traveling lane, on which the own vehicle travels, on the basis of the image data sent from the camera device 17b and determines a center position between the right and left lane lines LR and LL as a target traveling line Ld. Further, the driving assist ECU 10 calculates a curve radius, i.e., a curvature radius R of the target traveling line Ld and the position and a direction of the own vehicle in the traveling lane which is defined by the right and left lane lines LR and LL.

Then, the driving assist ECU 10 calculates a distance Dc between a front center position of the own vehicle and the target traveling line Ld in a lateral direction or width direction of the road and a difference angle θy between the target traveling line Ld and a traveling direction of the own vehicle. Hereinafter, the distance Dc will be referred to as “the center distance Dc” and the difference angle θy will be referred to as “the yaw angle θy”.

Further, the driving assist ECU 10 calculates a target yaw rate YRctgt at a predetermined calculation cycle on the basis of the center distance Dc, the yaw angle θy and the road curvature ν (=1/R) in accordance with a following expression (1). In the expression (1), K1, K2 and K3 are control gains. The target yaw rate YRctgt is a yaw rate which is set to cause the own vehicle to travel along the target traveling line Ld.

YRctgt=K1×Dc+K2×θy+K3×ν (1)

The driving assist ECU 10 calculates a target steering torque Trtgt for accomplishing the target yaw rate YRctgt at a predetermined calculation cycle on the basis of the target yaw rate YRctgt and the actual yaw rate YRa.

In particular, the driving assist ECU 10 previously stores a look-up table which defines a relationship between the target steering torque Trtgt and a difference between the target yaw rate YRctgt and the actual yaw rate YRa. The driving assist ECU 10 calculates the target steering torque Trtgt by applying the difference between the target yaw rate YRctgt and the yaw rate YRa to the look-up table. Then, the driving assist ECU 10 controls the steering motor 62 by using the steering ECU 60 such that the actual steering torque Tra corresponds to the target steering torque Trtgt. The summary of the lane keeping control has been described.

<Following-Travel Inter-Vehicle-Distance Control (ACC)>

The following-travel inter-vehicle-distance control is a control for causing the own vehicle to travel following a preceding vehicle which travels in front of the own vehicle while maintaining an inter-vehicle distance between the preceding vehicle and the own vehicle at a predetermined distance. The following-travel inter-vehicle-distance control is known (for example, JP 2014-148293 A, JP 2006-315491 A, JP 4172434 B and JP 4929777 B). Therefore, below, the following-travel inter-vehicle-distance control will be briefly described.

The driving assist ECU 10 executes the following-travel inter-vehicle-distance control when an execution of the following-travel inter-vehicle-distance control is requested by an operation of the operation switch 18.

In particular, the driving assist ECU 10 selects a vehicle, which the own vehicle should follow, on the basis of the target object information acquired by a surrounding sensor including the radar sensor 17a and the camera device 17b when the execution of the following-travel inter-vehicle-distance control is requested. The vehicle which the own vehicle should follow will be referred to as “the target vehicle”. For example, the driving assist ECU 10 determines whether or not a relative position of the target object (n) is within a target vehicle area. The relative position of the target object (n) is determined on the basis of the lateral distance Dfy(n) of the detected target object (n) and the inter-vehicle distance Dfx(n). The target vehicle area is an area previously determined such that the lateral distance Dfy(n) decreases as the inter-vehicle distance Dfx(n) increases. Then, when the relative position of the target object (n) is within the target vehicle area for a time equal to or longer than a predetermined time, the driving assist ECU 10 selects the target object (n) as the target vehicle (a).

Further, the driving assist ECU 10 calculates a target acceleration Gtgt in according with any of following expressions (2) and (3). In the expressions (2) and (3), Vfx(a) is a relative vehicle speed of the target vehicle (a) with respect to the own vehicle, k1 and k2 are predetermined positive gains or coefficients and ΔD1 is an inter-vehicle distance difference obtained by subtracting a target inter-vehicle distance Dtgt from the inter-vehicle distance Dfx(a) of the target vehicle (a) (AD1=Dfx(a)−Dtgt). The target inter-vehicle distance Dtgt is calculated by multiplying a target inter-vehicle time Ttgt by the vehicle speed SPD of the own vehicle (Dtgt=Ttgt×SPD). The target inter-vehicle time Ttgt is set by the driver using the operation switch 18.

The driving assist ECU 10 determines the target acceleration Gtgt in accordance with the following expression (2) when the value (k1×AD1+k2×Vfx(a)) is positive or zero. In the expression (2), ka1 is a positive gain or coefficient for accelerating the own vehicle and is set to a value equal to or smaller than “1”.

Gtgt(for acceleration)=ka1×(k1×AD1+k2×Vfx(a)) (2)

On the other hand, when the value (k1×AD1+k2×Vfx(a)) is negative, the driving assist ECU 10 determines the target acceleration Gtgt in accordance with the following expression (3). In the expression (3), kd1 is a gain or coefficient for decelerating the own vehicle and in this embodiment, is set to “1”.

Gtgt(for deceleration)=kd1×(k1×AD1+k2×Vfx(a)) (3)

When the target vehicle does not exist within the target vehicle area, the driving assist ECU 10 determines the target acceleration Gtgt on the basis of the vehicle speed SPD of the own vehicle and a target vehicle speed SPDtgt such that the vehicle speed SPD of the own vehicle corresponds to the target vehicle speed SPDtgt which is set depending on the target inter-vehicle time Ttgt.

The driving assist ECU 10 controls the engine actuators 31 by using the engine ECU 30 and if necessary, controls the brake actuator 41 by using the brake ECU 40 such that an acceleration of the own vehicle corresponds to the target acceleration Gtgt.

When the friction force application by the friction brake mechanism 42 continues for a long time after the own vehicle is stopped by the friction force application in the following-travel inter-vehicle-distance control, a temperature of the brake actuator 41 increases and then, may reach an excessive high temperature.

Accordingly, when the driving assist ECU 10 stops the own vehicle by the friction force application in the following-travel inter-vehicle-distance control, the driving assist ECU 10 measures a time Tacc elapsing from a time of stopping the own vehicle, that is, a time when the vehicle speed SPD of the own vehicle becomes zero. The driving assist ECU 10 maintains the own vehicle at the stopped state by the friction force application until the time Tacc reaches a predetermined time Taccth (for example, ten minutes). Hereinafter, the time Tacc will be referred to as “the friction force application continuation time Tacc” and the predetermined time Taccth will be referred to as “the predetermined continuation time Taccth”.

When the stopped state of the own vehicle by the friction force application continues and then, the friction force application continuation time Tacc reaches the predetermined continuation time Taccth, the driving assist ECU 10 locks the drive wheels by the engagement lock by the parking lock mechanism 24 and stops the friction force application. Thereby, the temperature of the brake actuator 41 can be prevented from increasing excessively and the own vehicle can be maintained at the stopped state. The summary of the following-travel inter-vehicle-distance control has been described.

<Process for Stopping Vehicle>

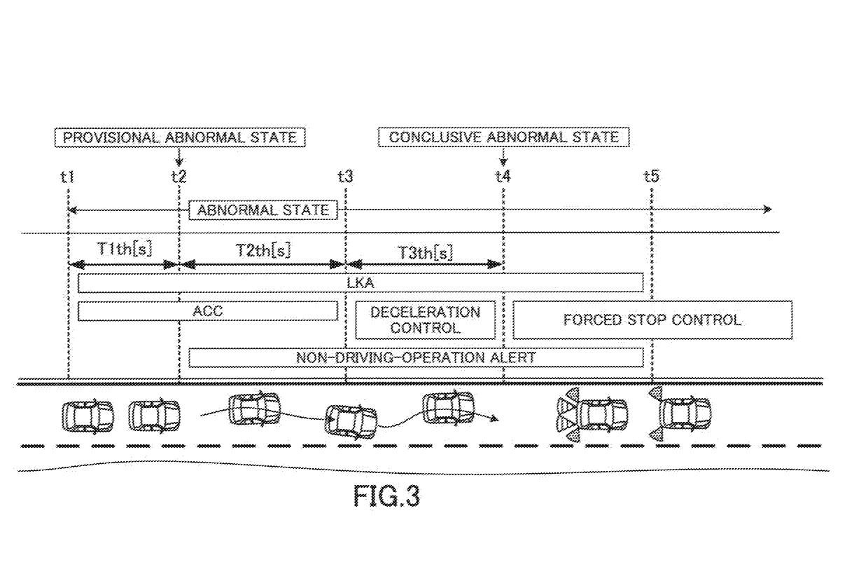

The driving assist ECU 10 provisionally determines that the driver is under the abnormal state at a time t2 in FIG. 3 when the driving assist ECU 10 has determined that driver is under the abnormal state for a predetermined time T1th from a time t1 in FIG. 3 when the driving assist ECU 10 first determines that the driver is under the abnormal state. Hereinafter, the predetermined time T1th will be referred to as “the first threshold time T1th” and the abnormal state which is provisionally determined will be referred to as “the provisional abnormal state”. When the driving assist ECU 10 first determines that the driver is under the provisional abnormal state, the driving assist ECU 10 changes a driver's state from a normal state, which has been set, to the provisional abnormal state. In this case, the driving assist ECU 10 performs an alerting for prompting the driver to perform driving operations.

When the driving assist ECU 10 determines that the driver is still under the abnormal state at a time t3 in FIG. 3 when a predetermined time T2th elapses from the time t2 when the driver's state is changed from the normal state to the provisional abnormal state, the driving assist ECU 10 stops the following-travel inter-vehicle-distance control and starts a deceleration control for activating the friction brake mechanism 42 to apply the friction force to the wheels of the own vehicle to decrease the vehicle speed SPD of the own vehicle at a predetermined first constant deceleration α1. At this time, the driving assist ECU 10 continues the lane keeping control. Hereinafter, the predetermined time T2th will be referred to as “the second threshold time T2th”.

When the driver knows the alerting and/or the deceleration of the own vehicle and performs the driving operations, the driving assist ECU 10 detects the driver's driving operation and returns the driver's state from the provisional abnormal state to the normal state. In this case, the driving assist ECU 10 stops the alerting for the driver which has been performed and the deceleration control which have been executed. At this time, the driving assist ECU 10 continues the lane keeping control and restart the following-travel inter-vehicle-distance control.

On the other hand, after the driving assist ECU 10 starts the deceleration control, the driver does not perform any driving operations and then, when a predetermined time T3th elapses at a time t4 in FIG. 3 from the time t3 when the deceleration control starts, a possibility that the driver is under the abnormal state, is large. In this case, the driving assist ECU 10 changes the driver's state from the provisional abnormal state to a conclusive abnormal state. Hereinafter, the predetermined time T3th will be referred to as “the third threshold time T3th”.

Further, the driving assist ECU 10 forbids the acceleration including the deceleration of the own vehicle derived from a change of the acceleration pedal operation amount AP, that is, forbids an acceleration pedal operation overriding. In other words, the driving assist ECU 10 cancels or ignores a driving state changing request or an acceleration request derived from an operation of the acceleration pedal 11a as far as the driving operation of the driver is not detected.

Therefore, when the engine torque TQdriver requested by the driver deriving from an operation of the acceleration pedal 11a by the driver is larger than zero while the driving assist ECU 10 forbids the acceleration pedal operation override, the driving assist ECU 10 sets the engine torque TQreq actually requested for the engine ECU 30 to zero. In this case, the engine ECU 30 causes the engine 32 to generate the engine torque necessary to the minimum for maintaining an operation of the engine 32. Hereinafter, the acceleration pedal operation override will be referred to as “the AOR”, the engine torque TQreq will be referred to as “the actual request torque TQreq” and the engine torque necessary to the minimum for maintaining the operation of the engine 32 will be referred to as “the idling torque”.

In addition to a setting of the actual request torque TQreq, the driving assist ECU 10 decelerates the own vehicle at a predetermined second constant deceleration α2 larger than the predetermined first constant deceleration α1, thereby to forcibly stop the own vehicle by the friction force application performed by the friction brake mechanism 42.

The driving assist ECU 10 continues to forbid the AOR at a time t5 in FIG. 3 of stopping the own vehicle by the forced stop control. In addition, the driving assist ECU 10 stops the friction force application by the friction brake mechanism 42 and locks the drive wheels by the engagement lock by the parking lock mechanism 24. Thereby, after the own vehicle stops, the own vehicle is maintained at the stopped state.

In addition, the driving assist ECU 10 continues the blinking of the hazard lamp 71 and the sound generation performed by the horn 92 when the driving assist ECU 10 stops the own vehicle by the forced stop control.

Hereinafter, a control for forbidding the AOR and forcibly stopping the own vehicle by the deceleration at the predetermined second constant deceleration α2 by the friction force application and after stopping the own vehicle, continuing to forbid the AOR, stopping the friction force application and starting the engagement lock, will be referred to as “the forced stop control”.

<Stop of Forced Stop Control>

The driving assist ECU 10 stops the forced stop control when the stop of the forced stop control is requested deriving from an operation of the stop request button 20 during an execution of the forced stop control. In particular, the driving assist ECU 10 permits the AOR, that is, stops the forbidding of the AOR. Further, if the own vehicle is braked by the friction force application, the driving assist ECU 10 stops the friction force application. In addition, the driving assist ECU 10 permits a stop of the blinking of the hazard lamp 71 and a stop of the sound generation performed by the horn 92.

When the hazard lamp switch 73 is operated while the stop of the blinking of the hazard lamp 71 is permitted, the blinking of the hazard lamp 71 is stopped. When the horn switch 93 is operated while the stop of the sound generation performed by the horn 92 is permitted, the sound generation performed by the horn 92 is stopped.

The summary of the operation of the embodiment apparatus has been described. When the own vehicle is maintained at the stopped state by the engagement lock, it is necessary to release the engagement lock in order to travel the own vehicle. In particular, the driving assist ECU 10 needs to disengage the parking lock pawl 25 of the parking lock mechanism 24 from the parking gear 27 by activating the parking lock actuator 23. Therefore, when the own vehicle is maintained at the stopped state by the engagement lock, the own vehicle cannot start to travel quickly, compared with a case that the own vehicle is maintained at the stopped state by the friction force application.

When the own vehicle is stopped during the execution of the following-travel inter-vehicle-distance control, that is, during an execution of a control other than the forced stop control, the own vehicle may start to travel quickly after the own vehicle is stopped. In this case, the own vehicle may be maintained at the stopped state by the friction force application.

With the operation of the embodiment apparatus, the own vehicle is maintained at the stopped state by the friction force application until the predetermined continuation time Taccth elapses after the own vehicle is stopped by the following-travel inter-vehicle-distance control. Thus, the own vehicle can start to travel quickly.

On the other hand, when the own vehicle is stopped by the forced stop control, a possibility that a quick start of a traveling of the own vehicle is requested after the own vehicle is stopped, is small. Therefore, even when the friction force application is stopped and the own vehicle is maintained at the stopped state by the engagement lock soon after the own vehicle is stopped, a possibility that a problem as to the start of the traveling of the own vehicle arises, is small.

In this regard, a rescuer for rescuing the driver under the abnormal state may mistakenly operate the stop request button 20 and thus, the forced stop control may be stopped. In this case, if the acceleration pedal 11a is operated while the own vehicle is maintained at the stopped state by the friction force application, the own vehicle may be suddenly accelerated during a rescuing of the driver. The engagement lock is not released even when the forced stop control is stopped. Accordingly, the own vehicle may be maintained at the stopped state by the engagement lock after the own vehicle is stopped.

With the operation of the embodiment apparatus, when the own vehicle is stopped by the forced stop control, the own vehicle is maintained at the stopped state by the engagement lock. Thus, a possibility that the own vehicle can be prevented from being suddenly accelerated, is large.

### Concrete Operation of Embodiment Apparatus

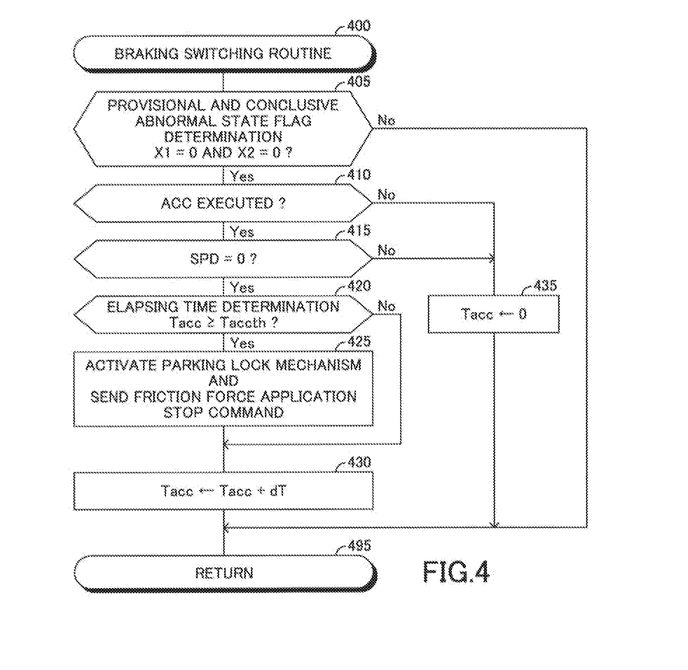

Next, a concrete operation of the embodiment apparatus will be described. The CPU of the driving assist ECU 10 of the embodiment apparatus is configured or programmed to execute a normal state routine shown by a flowchart in FIG. 4 each time a predetermined time dT elapses.

Therefore, at a predetermined timing, the CPU starts a process of a step 400 in FIG. 4 and then, proceeds with the process to a step 405 to determine whether or not values of a provisional abnormal state flag X1 and a conclusive abnormal state flag X2 are “0”.

The provisional abnormal state flag X1 indicates that the driver's state is determined to be the provisional abnormal state when the value of the provisional abnormal state flag X1 is “1”. The conclusive abnormal state flag X2 indicates that the driver's state is determined to be the conclusive abnormal state when the value of the conclusive abnormal state flag X2 is “1”. When the values of the provisional and conclusive abnormal state flags X1 and X2 are “0”, the flags X1 and X2 indicate that the driver's state is determined to be the normal state.

The values of the provisional and conclusive abnormal state flags X1 and X2 are initialized to be set to “0”, respectively when an ignition switch (not shown) is set at an ON position.

When the values of the provisional and conclusive abnormal state flags X1 and X2 are “0”, that is, when the driver's state is the normal state, the CPU determines “Yes” at the step 405 and then, proceeds with the process to a step 410 to determine whether or not the following-travel inter-vehicle-distance control is executed.

When the following-travel inter-vehicle-distance control is executed, the CPU determines “Yes” at the step 410 and then, proceeds with the process to a step 415 to determine whether or not the vehicle speed SPD of the own vehicle is zero.

When the vehicle speed SPD of the own vehicle is zero, the CPU determines “Yes” at the step 415 and then, proceeds with the process to a step 420 to determine whether or not the friction force application continuation time Tacc is equal to or larger than the predetermined continuation time Taccth.

Immediately after the own vehicle is stopped by the friction force application in the following-travel inter-vehicle-distance control, the friction force application continuation time Tacc is smaller than the predetermined continuation time Taccth. In this case, the CPU determines “No” at the step 420 and then, executes a process of a step 430 described below. Then, the CPU proceeds with the process to a step 495 to terminate this routine once.

Step 430: The CPU increases the friction force application continuation time Tacc by the predetermined time dT. The predetermined time dT is equal to the predetermined time dT which is an execution cycle of this routine.

When the friction force application in the following-travel inter-vehicle-distance control continues and then, the friction force application continuation time Tacc becomes equal to or larger than the predetermined continuation time Taccth, the CPU determines “Yes” at the step 420 and then, executes sequentially a process of a step 425 described below and the process of the step 430. Then, the CPU proceeds with the process to the step 495 to terminate this routine once.

Step 425: The CPU activates the parking brake actuator 23 to activate the parking lock mechanism 24 and sends a friction force application stop command to the brake ECU 40. Thereby, the engagement lock by the parking lock mechanism 24 starts. When receiving the friction force application stop command, the brake ECU 40 stops the friction force application.

When the following-travel inter-vehicle-distance control is not executed upon an execution of the process of the step 410, the CPU determines “No” at the step 410 and then, executes a process of a step 435 described below. Also, when the vehicle speed SPD of the own vehicle is larger than zero upon an execution of the process of the step 415, the determines “No” at the step 415 and then, executes the process of the step 435. Then, the CPU proceeds with the process to the step 495 to terminate this routine once.

Step 435: The CPU clears the friction force application continuation time Tacc.

Further, when the value of any of the provisional and conclusive abnormal state flags X1 and X2 is “1” upon an execution of the process of the step 405, the CPU determines “No” at the step 405 and then, proceeds with the process directly to the step 495 to terminate this routine once.

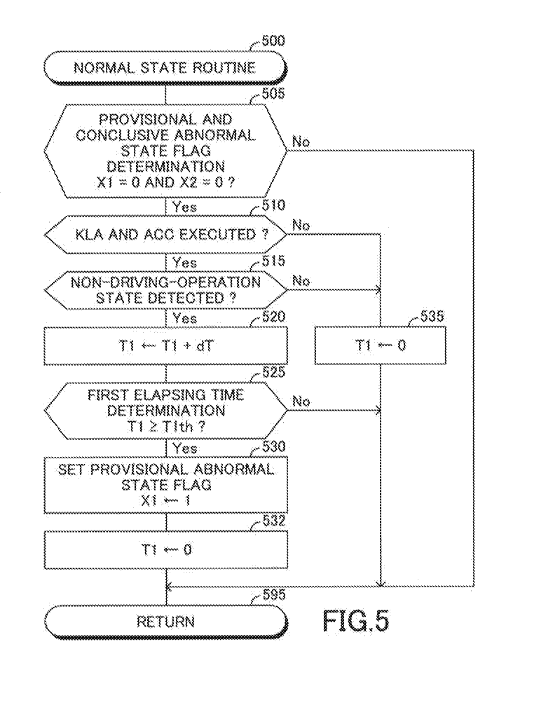

Further, the CPU is configured or programmed to execute a normal state routine shown by a flowchart in FIG. 5 each time a predetermined time dT elapses. Therefore, at a predetermined timing, the CPU starts a process of a step 500 in FIG. 5 and then, proceeds with the process to a step 505 to determine whether or not the values of the provisional abnormal state flag X1 and the conclusive abnormal state flag X2 are “0”.

As described above, the provisional abnormal state flag X1 indicates that the driver's state is determined to be the provisional abnormal state when the value of the provisional abnormal state flag X1 is “1”. The conclusive abnormal state flag X2 indicates that the driver's state is determined to be the conclusive abnormal state when the value of the conclusive abnormal state flag X2 is “1”. When the values of the provisional and conclusive abnormal state flags X1 and X2 are “0”, the flags X1 and X2 indicate that the driver's state is determined to be the normal state.

The values of the provisional and conclusive abnormal state flags X1 and X2 are initialized to be set to “0”, respectively when an ignition switch (not shown) is set at an ON position.

Immediately after the ignition switch is set at the ON position, the values of the provisional and conclusive abnormal state flags X1 and X2 are “0”. Thus, the CPU determines “Yes” at the step 505 and then, proceeds with the process to a step 510 to determine whether or not the lane keeping control (LKA) and the following-travel inter-vehicle-distance control (ACC) are executed.

When the lane keeping control and the following-travel inter-vehicle-distance control are executed, the CPU determines “Yes” at the step 510 and then, proceeds with the process to a step 515 to determine whether or not the non-driving-operation state that the driver does not take any driving action, is detected.

The non-driving-operation state is a state that one or more parameters such as the acceleration pedal operation amount AP, the brake pedal operation amount BP, the actual steering torque Tra and a signal level of the stop lamp switch 13 which are changed deriving from the driving operation of the driver, does/do not change. In this embodiment, the CPU determines a state that the acceleration pedal operation amount AP, the brake pedal operation amount BP and the actual steering torque Tra do not change and the actual steering torque Tra is zero as the non-driving-operation state.

When the non-driving-operation state is detected, the CPU determines “Yes” at the step 515 and then, executes a process of a step 520 described below. Then, the CPU proceeds with the process to a step 525.

Step 520: The CPU increases a time T1 elapsing from a time when the non-driving-operation state is first detected at the step 515 by a predetermined time dT. The predetermined time dT is equal to the predetermined time dT which corresponds to an execution cycle of this normal state routine. Hereinafter, the time T1 will be referred to as “the first elapsing time T1”.

When the CPU proceeds with the process to the step 525, the CPU determines whether or not the first elapsing time T1 is equal to or larger than the first threshold time T1th. Immediately after the CPU determines “Yes” at the step 515, the first elapsing time T1 is smaller than the first threshold time T1th. In this case, the CPU determines “No” at the step 525 and then, proceeds with the process to a step 595 to terminate this routine once.

On the other hand, when the non-driving-operation state continues and then, the first elapsing time T1 becomes equal to or larger than the first threshold time T1th, the CPU determines “Yes” at the step 525 and then, sequentially executes processes of steps 530 and 532 described below. Then, the CPU proceeds with the process to the step 595 to terminate this routine once.

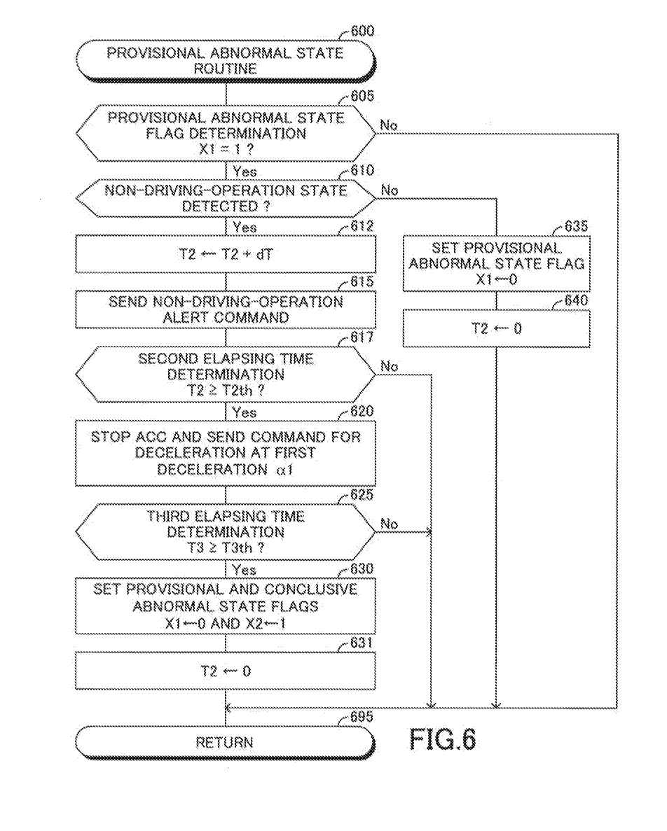

Step 530: The CPU sets the value of the provisional abnormal state flag X1 to “1”. After the value of the provisional abnormal state flag X1 is set to “1”, the CPU determines “No” at the step 505 and determines “Yes” at a step 605 in FIG. 6 described later. Therefore, in place of the normal state routine shown in FIG. 5, a provisional abnormal state routine shown in FIG. 6 substantially functions.

Step 532: The CPU clears the first elapsing time T1. The first elapsing time T1 is also cleared when the ignition switch is set at the ON position.

When any of the lane keeping control and the following-travel inter-vehicle-distance control is not executed upon an execution of the process of the step 510, the CPU determines “No” at the step 510 and then, executes a process of a step 535 described below. Also, when the non-driving-operation state is not detected upon an execution of the process of the step 515, the CPU determines “No” at the step 515 and then, executes the process of the step 535. Then, the CPU proceeds with the process to the step 595 to terminate this routine once.

Step 535: The CPU clears the first elapsing time T1.

When any of the values of the provisional and conclusive abnormal state flags X1 and X2 is “1” upon an execution of the process of the step 505, the CPU determines “No” at the step 505 and then, proceeds with the process directly to the step 595 to terminate this routine once.

Further, the CPU is configured or programmed to execute a provisional abnormal state routine shown by a flowchart in FIG. 6 each time the predetermined time dT elapses. Therefore, at a predetermined timing, the CPU starts a process from a step 600 in FIG. 6 and then, proceeds with the process to a step 605 to determine whether or not the value of the provisional abnormal state flag X1 is “1”. When the value of the provisional abnormal state flag X1 is set to “1” at the step 530 in FIG. 5, that is, when the driver's state is determined to be the provisional abnormal state, the CPU determines “Yes” at the step 605 and then, proceeds with the process to a step 610.

When the CPU proceeds with the process to the step 610, the CPU determines whether or not the non-driving-operation state is detected. This determination is the same as the determination of the step 515 in FIG. 5. When the non-driving-operation state is detected, the CPU determines “Yes” at the step 610 and then, sequentially executes processes of steps 612 and 615 described below. Then, the CPU proceeds with the process to a step 617.

Step 612: The CPU increases a time T2 elapsing from a time when the driver's state is determined to be the provisional abnormal state by the predetermined time dT. The predetermined time dT is equal to the predetermined time dT which corresponds to an execution cycle of this provisional abnormal routine. Hereinafter, the time T2 will be referred to as “the second elapsing time T2”.

Step 615: The CPU sends a non-driving-operation alert command to the alert ECU 80. Thereby, the alert ECU 80 causes the buzzer 81 to generate alerting sounds and causes the display device 82 to blink the warning lamp and display the alerting message for prompting the driver to operate any of the acceleration pedal 11a, the brake pedal 12a and the steering wheel SW.

When the CPU proceeds with the process to the step 617, the CPU determines whether or not the second elapsing time T2 is equal to or larger than the second threshold time T2th. Immediately after the value of the provisional abnormal state flag X1 is set to “1” at the step 530 in FIG. 5, that is, when the driver's state is determined to be the provisional abnormal state, the second elapsing time T2 is smaller than the second threshold time T2th. In this case, the CPU determines “No” at the step 617 and then, proceeds with the process to a step 695 to terminate this routine once.

On the other hand, when the driver's state continues to be determined as the provisional abnormal state and then, the second elapsing time T2 becomes equal to or larger than the second threshold time T2th, the CPU determines “Yes” at the step 617 and then, executes a process of a step 620 described below. Then, the CPU proceeds with the process to a step 625.

Step 620: The CPU stops the following-travel inter-vehicle-distance control (ACC) and sends, to the engine and brake ECUs 30 and 40, a command for causing the engine and brake ECUs 30 and 40 to execute the deceleration control for decelerating the own vehicle at the predetermined first constant deceleration α1. In this case, the CPU calculates the acceleration of the own vehicle on the basis of a change amount per unit time of the vehicle speed SPD acquired on the basis of the detection signal sent from the vehicle speed sensor 16 and sends, to the engine and brake ECUs 30 and 40, a command for causing the calculated acceleration to correspond to the predetermined first constant deceleration α1. In this embodiment, the predetermined first constant deceleration α1 is set to a deceleration having an extremely small absolute value.

When the CPU proceeds to the process to the step 625, the CPU determines whether or not a time T3 elapsing from a time when the deceleration control is started at the step 620 is equal to or larger than the third threshold time T3th. The time T3 is acquired by subtracting the second threshold time T2th from the second elapsing time T2 (T3=T2−T2th). Hereinafter, the time T3 will be referred to as “the third elapsing time T3”.

Immediately after the process of the step 620 is first executed, that is, immediately after the deceleration control is started, the third elapsing time T3 is smaller than the third threshold time T3th. In this case, the CPU determines “No” at the step 625 and then, proceeds with the process to the step 695 to terminate this routine once.

On the other hand, when the driver's state continues to be determined as the provisional abnormal state and then, the third elapsing time T3 becomes equal to or larger than the third threshold time T3th, the CPU determines “Yes” at the step 625 and then, sequentially executes processes of steps 630 and 631 described below. Then, the CPU proceeds with the process to the step 695 to terminate this routine once.

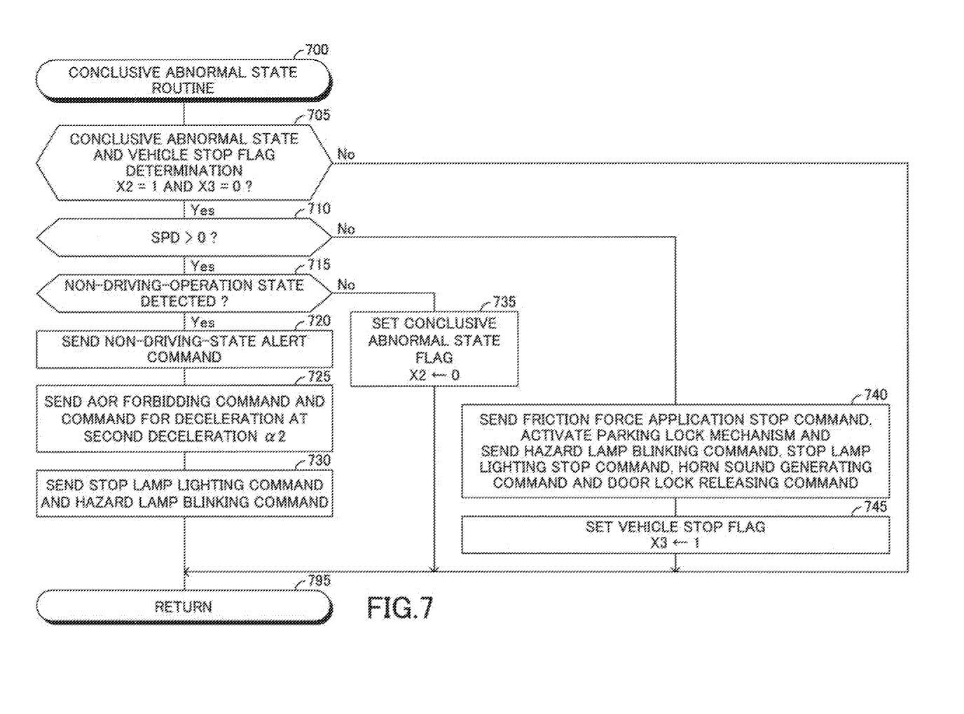

Step 630: The CPU sets the value of the provisional abnormal state flag X1 to “0” and sets the value of the conclusive abnormal state flag X2 to “1”. Thereby, the CPU determines “No” at the step 605 and determines “Yes” at a step 705 in FIG. 7 described later. In this case, in place of the provisional abnormal state routine shown in FIG. 6, a conclusive abnormal state routine shown in FIG. 7 substantially functions.

Step 631: The CPU clears the second elapsing time T2. The second elapsing time T2 is also cleared when the ignition switch is set at the ON position.

When the driving operation by the driver is detected upon an execution of the process of the step 610, the CPU determines “No” at the step 610 and then, sequentially executes processes of steps 635 and 640 described below. Then, the CPU proceeds with the process to the step 695 to terminate this routine once.

Step 635: The CPU sets the value of the provisional abnormal state flag X1 to “0”. Thereby, the values of the provisional and conclusive abnormal state flags X1 and X2 are set to “0”, the driver's state is set to the normal state. In this case, the CPU determines “Yes” at the step 505 in FIG. 5. Thus, in place of the provisional abnormal state routine shown in FIG. 6, the normal state routine shown in FIG. 5 substantially functions.

Step 640: The CPU clears the second elapsing time T2.

Further, when the value of the provisional abnormal state flag X1 is “0” upon an execution of the process of the step 605, the CPU determines “No” at the step 605 and then, proceeds with the process directly to the step 695 to terminate this routine once.

Further, the CPU is configured or programmed to execute a conclusive abnormal state routine shown by a flowchart in FIG. 7 each time the predetermined time dT elapses. Therefore, at a predetermined timing, the CPU starts a process from a step 700 in FIG. 7 and then, proceeds with the process to a step 705 to determine whether or not the value of the conclusive abnormal flag X2 is “1”. When the value of the conclusive abnormal flag X2 is set to “1” at the step 630 in FIG. 6, the CPU determines “Yes” at the step 705 and then, proceeds with the process to a step 710.

When the CPU proceeds with the process to the step 710, the CPU determines whether or not the vehicle speed SPD is larger than zero, that is, the own vehicle travels. When the process of the step 710 is first executed, the own vehicle does not stop. In this case, the CPU determines “Yes” at the step 710 and then, proceeds with the process to a step 715.

When the CPU proceeds with the process to the step 715, the CPU determines whether or not the non-driving-operation state is detected. The processes of the step 715 may be the same as the processes of the step 515 in FIG. 5 and the step 610 in FIG. 6 or may be configured to additionally include a condition that the driving operation is surely detected.

When the non-driving-operation state is detected, the CPU determines “Yes” at the step 715 and then, sequentially executes processes of steps 720 to 730 described below. Then, the CPU proceeds with the process to a step 795 to terminate this routine once.

Step 720: The CPU sends the non-driving-operation alert command to the alert ECU 80. Thereby, the alert ECU 80 performs the non-driving-operation alert by using the buzzer 81 and the display device 82. The non-driving-operation alert performed at the step 720 may be the same as the non-driving-operation alert performed at the step 615 in FIG. 6 or may be configured such that a level of the alerting increases, compared with the non-driving-operation alert performed at the step 615 (for example, a level of the sound generated by the buzzer 81 increases).

Step 725: The CPU sends a command for forbidding the AOR to the engine ECU 30 and sends, to the brake ECU 40, a command for decelerating the own vehicle at the predetermined second constant deceleration α2.

In this case, the forced stop control is executed. In particular, the engine ECU 30 sets the actual request torque requested for the engine 32 to zero, independently of a value of the acceleration pedal operation amount AP (i.e., a value of the driver request torque, a value of the driver request driving force) and activates the engine actuators 31 such that the engine torque output from the engine 32 corresponds to the idling torque.

The brake ECU 40 activates the brake actuator 41 such that the own vehicle is decelerated at the predetermined second constant deceleration α2. In this embodiment, the predetermined second constant deceleration α2 is set to a value having an absolute value larger than an absolute value of the predetermined first constant deceleration α1.

Step 730: The CPU sends, to the meter ECU 70, a lighting command for lighting the stop lamp 72 and a blinking command for blinking the hazard lamp 71. Thereby, the meter ECU 70 lights the stop lamp 72 and blinks the hazard lamp 71. Thereby, a driver of a vehicle following the own vehicle can be alerted.

The driving assist ECU 10 decelerates the own vehicle by executing the aforementioned processes repeatedly.

When the driving operation of the driver is detected upon an execution of the process of the step 715, the CPU determines “No” at the step 715 and then, executes a process of a step 735 described below. Then, the CPU proceeds with the process to the step 795 to terminate this routine once.

Step 735: The CPU sets the value of the conclusive abnormal state flag X2 to “0”. Thereby, the deceleration control, the alerting for the driver of the own vehicle and the alerting for the driver of the vehicle following the own vehicle are stopped and a normal vehicle control for controlling the traveling of the own vehicle only on the basis of the driving operation of the driver of the own vehicle is started. Therefore, the lane keeping control and the following-travel inter-vehicle-distance control are executed, depending on a setting state of the operation switch 18.

The CPU may be configured or programmed not to execute the process of the step 735 when the driving operation of the driver of the own vehicle is detected during the execution of the forced stop control. For example, when the driving operation of the driver of the own vehicle is detected during the execution of the forced stop control, the CPU may be configured or programmed to continue to decelerate the own vehicle at the predetermined second constant deceleration α2 while forbidding the AOR and set the value of the conclusive abnormal state flag X2 to “0” after the own vehicle stops.

When no detection of the driving operation of the driver continues and then, the own vehicle is stopped by the deceleration at the predetermined second constant deceleration α2, that is, the vehicle speed SPD of the own vehicle becomes zero, the CPU determines “No” at the step 710 and then, sequentially executes processes of steps 740 to 745 described below. Then, the CPU proceeds with the process to the step 795 to terminate this routine once.

Step 740: The CPU sends a friction force application stop command to the brake ECU 40, activates the parking brake actuator 23 to activate the parking lock mechanism 24, sends a hazard lamp blinking command and a stop lamp lighting stop command to the meter ECU 70 and sends a horn sound generating command and a door lock releasing command to the body ECU 90.

Thereby, the engagement lock by the parking lock mechanism 24 starts. When receiving the friction force application stop command, the brake ECU 40 stops the friction force application by the friction brake mechanism 42. When receiving the hazard lamp blinking command and the stop lamp lighting stop command, the meter ECU 70 blinks the hazard lamp 71 and stops the lighting of the stop lamp 72. When receiving the horn sound generating command and the door lock releasing command, the body ECU 90 causes the horn 92 to generate the sounds and causes the door lock device 91 to release the door lock.

Step 745: The CPU sets the value of the vehicle stop flag X3 to “1”. The vehicle stop flag X3 indicates that the own vehicle is forcibly stopped by the forced stop control when the value of the vehicle stop flag X3 is “1”.

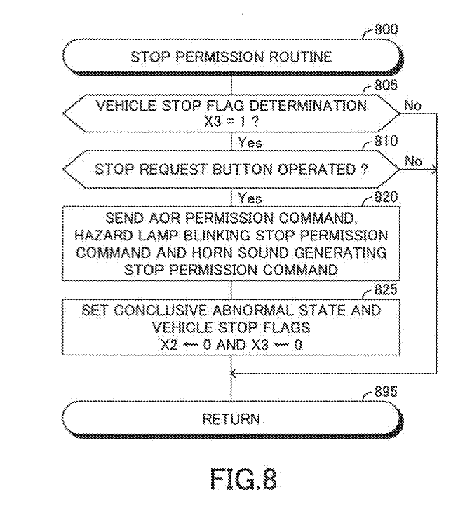

Further, the CPU is configured or programmed to execute a stop permission routine shown by a flowchart in FIG. 8 each time the predetermined time dT elapses. Therefore, at a predetermined timing, the CPU start a process from a step 800 and then, proceeds with the process to a step 805 to determine whether or not the value of the vehicle stop flag X3 is “1”. When the value of the vehicle stop flag X3 is “1”, the CPU determines “Yes” at the step 805 and then, proceeds with the process to a step 810 to determine whether or not the stop request button 20 is operated after the own vehicle is stopped by the process of the step 725 in FIG. 7.

When the stop request button 20 is operated after the own vehicle is stopped, the CPU determines “Yes” at the step 810 and then, sequentially executes processes of steps 820 and 825 described below. Then, the CPU proceeds with the process to a step 895 to terminate this routine once.

Step 820: The CPU sends an AOR permission command to the engine ECU 30, sends a hazard lamp blinking stop permission command to the meter ECU 70 and sends a horn sound generating stop permission command to the body ECU 90.

When receiving the AOR permission command, the engine ECU 30 permits the AOR. When receiving the hazard lamp blinking stop permission command, the meter ECU 70 stops the blinking of the hazard lamp 71 deriving from the operation of the hazard lamp switch 73. When receiving the horn sound generating stop permission command, the body ECU 90 stops the sound generation performed by the horn 92 deriving from the operation of the horn switch 93.

Step 825: The CPU sets the values of the conclusive abnormal state and vehicle stop flags X2 and X3 to “0”, respectively.

When the value of the vehicle stop flag X3 is “0” upon an execution of the process of the step 805, the CPU determines “No” at the step 805 and then, proceeds with the process directly to the step 895 to terminate this routine once. Also, when the stop request button 20 is not operated upon an execution of the process of the step 810, the CPU determines “No” at the step 810 and then, proceeds with the process directly to the step 895 to terminate this routine once.

The concrete operation of the embodiment apparatus has been described. With the routines shown in FIGS. 5 to 7, when the driver is under the abnormal state that the driver loses his/her ability of driving the own vehicle (refer to the determination “Yes” at the step 715 in FIG. 7), the own vehicle is braked to be stopped (refer to the process of the step 725 in FIG. 7).

In addition, after the own vehicle is stopped by the forced stop control, the own vehicle is maintained at the stopped state by the engagement lock by the parking lock mechanism 24 (refer to the process of the step 740 in FIG. 7). Therefore, the possibility that the own vehicle is prevented from being suddenly accelerated, is large.

It should be noted that the present disclosure is not limited to the aforementioned embodiment and various modifications can be employed within the scope of the present disclosure.

The embodiment apparatus performs the abnormal determination of the driver on the basis of the time of the continuation of the non-driving-operation state, however the embodiment apparatus may be configured or programmed to perform the abnormal determination of the driver by using so-called driver monitor technique, for example, described in JP 2013-152700. In this case, a camera for taking an image of the driver of the own vehicle is provided on a member (for example, the steering wheel, a pillar and the like) inside the own vehicle. The driving assist ECU 10 monitors a direction of a line of sight of the driver or the face of the driver by using the image taken by the camera. The driving assist ECU 10 determines that the driver is under the abnormal state when the direction of the line of the sight of the driver or the face of the driver continues to be a direction which the line of the sight of the driver or the face of a driver under the normal state does not direct for over a predetermined time. This abnormal state determination using the image taken by the camera can be used for the determination of the provisional abnormal state (refer to the process of the step 515 in FIG. 5) and the determination of the conclusive abnormal state (refer to the process of the step 610 in FIG. 6).

In place of locking the drive wheels by the parking lock mechanism 24 and stopping the friction force application by the friction brake mechanism 42 when the own vehicle is stopped by the forced stop control, the embodiment apparatus may be configured or programmed to lock the drive wheels by the parking lock mechanism 24 and stop the friction force application by the friction brake mechanism 42 when a time Thoji (a second time) shorter than the predetermined continuation time Taccth (a first time) used in the ACC control, elapses after the own vehicle is stopped by the forced stop control. The time Thoji may be set to a value near zero.

Further, the embodiment apparatus may be configured or programmed to lock the drive wheels by the engagement lock by the parking lock mechanism 24 and stop the friction force application by the friction brake mechanism 42 when the friction force application continuation time elapsing from a stop of the own vehicle reaches the predetermined continuation time while the own vehicle is stopped by the friction force application by the friction brake mechanism 42 in a particular control other than the forced stop control.

In this case, the particular control includes the following-travel inter-vehicle-distance control as well as a control for stopping the own vehicle by the friction force application by the friction brake mechanism 42 in response to an operation of the brake pedal 12a by the driver. Therefore, a predicted time until a start of a traveling of the own vehicle is requested after the own vehicle is stopped by the friction force application in the particular control is shorter than a predicted time until the start of the traveling of the own vehicle is requested after the own vehicle is stopped by the friction force application in the forced stop control.

Further, the embodiment apparatus locks the drive wheels by the engagement lock by the parking lock mechanism 24 when stopping the own vehicle by the forced stop control. In this regard, the embodiment apparatus may be configured or programmed to lock wheels of the own vehicle other than the drive wheels when stopping the own vehicle by the forced stop control.

Further, the embodiment apparatus may be configured or programmed to stop the friction force application by the friction brake mechanism 42 and activates the parking brake actuator 51 to apply the friction force to the wheels, thereby to maintain the own vehicle at the stopped state when stopping the own vehicle by the forced stop control and then, stop the friction force application by the parking brake actuator 51 and maintain the own vehicle at the stopped state by the engagement lock by the parking lock mechanism 24 when the time (the second time) shorter than the predetermined continuation time Taccth (the first time) elapses.

What is claimed is:

1. A vehicle traveling control apparatus applied to a vehicle comprising:
a friction braking device for performing a friction force application for applying a friction force to the vehicle to brake the vehicle; and
a lock device for performing an engagement lock for locking at least one wheel of the vehicle by engaging a lock member with a rotation member which rotates together with the at least one wheel,
the vehicle traveling control apparatus comprising an electric control unit configured:
to continuously determine whether or not a driver of the vehicle is under an abnormal state that the driver loses an ability of driving the vehicle;
to execute a forced stop control for stopping the vehicle by braking the vehicle by the friction force application in response to the electric control unit determining that the driver is under the abnormal state;
to execute a particular control for stopping the vehicle by braking the vehicle by the friction force application when a predetermined vehicle stop condition is satisfied while the electric control unit determines that the driver is not under the abnormal state; and
to perform one of a stop of the friction force application and a permission of a stop of the friction force application when a stop of the forced stop control is requested while the vehicle is maintained at a stopped state by the friction force application,
wherein a time predicted to be taken until a start of a traveling of the vehicle is requested when the vehicle stopped by the particular control, is shorter than a time predicted to be taken until the start of the traveling of the vehicle is requested when the vehicle stopped by the forced stop control, and
wherein the electric control unit is configured:
to stop the friction force application and maintain the vehicle at the stopped state by the engagement lock when the vehicle is maintained at the stopped state by the friction force application at a time of an elapse of a first time from a time of a stop of the vehicle by the friction force application in the particular control; and
to stop the friction force application and maintain the vehicle at the stopped state by the engagement lock when the vehicle is maintained at the stopped state by the friction force application at a time of an elapse of a second time shorter than the first time from the time of the stop of the vehicle by the friction force application in the forced stop control.

2. The vehicle traveling control apparatus according to claim 1, wherein the particular control is a following-travel inter-vehicle-distance control for controlling an acceleration and a deceleration of an own vehicle which is the vehicle such that a distance between the own vehicle and a preceding vehicle traveling in front of the own vehicle is maintained at a set distance.

3. The vehicle traveling control apparatus according to claim 1, wherein the friction braking device is a hydraulic braking device for generating the friction force by hydraulic pressure.

4. The vehicle traveling control apparatus according to claim 1, wherein the second time is set to zero.
